(19) United States
(12) Patent Application Publication
(10) Pub. No.: US 2006/0263140 A1
(43) Pub. Date: Nov. 23, 2006

(54) Extruding container of applying filler

(75) Inventor: Yoshikazu Tani, Tokyo (JP)

Correspondence Address: BACON & THOMAS, PLLC, 625 SLATERS LANE, FOURTH FLOOR, ALEXANDRIA, VA, 22314, US

(73) Assignee: TOKIWA CORPORATION, Gifu (JP)

(21) Appl. No.: 11/454,946

(22) Filed: Jun. 19, 2006

Related U.S. Application Data
(63) Continuation-in-part of application No. 10/551,444.

(30) Foreign Application Priority Data
Oct. 11, 2004 (JP) 2004-326946

(51) Int. Cl. B43K 21/02

(52) U.S. Cl. 401/55

(57) ABSTRACT

A user-friendly extruding container of applying filler is structured such that, when an operating tube 3 and a main body tube 2 are relatively rotated in one direction, a movable body 6 moves forward by an engagement portion constituted by a female thread 4c and a male thread 6b and the rotation preventing portion constituted by an engagement portion 6e of the movable body 6 and an engagement portion 3d of the operating tube 3 to extrude applying filler for application with giving click feeling by the click mechanism 11 constituted by a tubular click spring member with the click tooth 12a and the compression spring portion 12b between the tubular body 4 and the operating tube 3 and, when rotated in the reverse direction, the movable body 6 moves backward with giving click feeling, whereby a user can perceive forward movement and returning of the movable body 6.

This is a continuation-in-part application of U.S. patent application Ser. No. 10/551,444 filed Jul. 15, 2005, entitled EXTRUDING CONTAINER OF APPLYING FILLER.

### TECHNICAL FIELD

The present invention relates to an extruding container of an applying filler for extruding the applying filler so as to apply.

### BACKGROUND ART

In conventional, as a movable body feeding apparatus provided for use by extruding an applying filler, for example, a liquid filler installed in a container, there has been known a movable body feeding apparatus which is provided with a main body tube in which a filling region where an applying filler is filled is provided in an inner portion, and an operating tube provided in a rear end portion of the main body tube so as to be relatively rotatable, and is structured such that when the main body tube and the operating tube are relatively rotated, the main body tube and a movable body received within the operating tube move forward, and the applying filler is extruded to a leading end side on the basis of a forward movement of a piston provided in a leading end of the movable body, whereby it is possible to apply the applying filler to a portion to be applied through an opening of a discharge cover attached to the leading end of the main body tube (for example, refer to Japanese Unexamined Patent Publication No. 2004-89687

### DISCLOSURE OF THE INVENTION

### Problem to be Solved by the Invention

In this case, it is also considered that the movable body is made to move backward in the movable body feeding apparatus mentioned above, and a user-friendly structure is required in the movable body feeding apparatus in which the movable body moves backward as mentioned above.

The present invention is made for achieving the problem mentioned above, and an object of the present invention is to provide an extruding container of an applying filler having a user-friendly structure.

### Means for Solving the Problem

In accordance with the present invention, there is provided an applying filler extruding container capable of extruding an applying filler filled in a filling region within a container to a leading end side on the basis of a forward movement of a movable body arranged within the container, wherein the container comprises:

an operating tube structured in a closed-end tube and constituting a rear portion of the container; and

a main body tube structured such as to be relatively rotatable in a leading end side of the operating tube,

wherein a tubular body arranged so as to be non-rotatable and immovable in an axial direction and having a female thread in an inner circumference is provided in a middle portion of the inner circumference of the main body tube,

wherein a male thread engaging with the female thread is provided in an outer circumference of the movable body,

wherein a protruding portion is provided in a bottom portion of the operating tube so as to extend in an axial direction,

wherein an engagement portion provided in the movable body is engaged with an engagement portion provided in the protruding portion of the operating tube so as to be non-rotatable and movable in the axial direction, and a rotation preventing portion of the movable body is structured by the engagement portions,

wherein a click spring member structured in a tubular shape and having a click tooth and a compression spring portion is arranged in such a manner that the movable body passes through an inner side thereof, and a click mechanism is structured by being pinched between the tubular body and an inner portion of the operating tube, and

wherein when the operating tube and the main body tube are relatively rotated in one direction or the other direction corresponding to an opposite direction to the one direction, the movable body moves forward or backward by the engagement portion constituted by the female thread and the male thread and the rotation preventing portion, and a click feeling is given by the click mechanism at this time.

In accordance with the applying filler extruding container having the structure mentioned above, when the operating tube and the main body tube are relatively rotated in one direction, the movable body moves forward by the engagement portion constituted by the female thread and the male thread and the rotation preventing portion constituted by the engagement portion of the movable body and the engagement portion of the protruding portion of the operating tube, so that the applying filler filled in the filling region is extruded forward to be ready to apply it, and at the time of forward movement, a click feeling is given by the click mechanism constituted by the click spring member which is structured in a tubular shape, provided with the click tooth and the compression spring portion, arranged in such a manner that the movable body passes through an inner side thereof and pinched between the tubular body and an inner portion of the operating tube. On the other hand, when the operating tube and the main body tube are relatively rotated in the other direction corresponding to an opposite direction to the one direction, the movable body moves backward by the engagement portion and the rotation preventing portion, and a click feeling is given by the click mechanism at the time of backward movement. Accordingly, a user can perceive forward movement and returning of the movable body and such is user-friendly.

In this case, as the click tooth, there can be specifically mentioned a chevron structure having an upward incline and a downward incline along a circumferential direction.

Further, as the click mechanism, there can be specifically mentioned a structure in which the click spring member is arranged in such a manner that the click tooth is directed toward the bottom portion side of the operating tube, and a predetermined engagement portion click engaging with the click tooth is provided in an inner portion of the operating tube.

Further, as the applying filler, there can be specifically mentioned a liquid filler.

### EFFECT OF THE INVENTION

As mentioned above, in accordance with the applying filler extruding container of the present invention, since the forward moving degree and the returning degree of the movable body are detected by the user, it is possible to provide a user-friendly applying filler extruding container.

### BRIEF DESCRIPTION OF THE DRAWINGS

FIG. 1 is a longitudinal sectional view showing an applying filler extruding container in accordance with an embodiment of the present invention;

FIG. 2 is a longitudinal sectional view showing a state that a cap of the applying filler extruding container in accordance with the embodiment of the present invention is taken off, and that a movable body is at a maximum forward moving time;

FIG. 3 is a longitudinal sectional view showing a main body tube in FIGS. 1 and 2;

FIG. 4 is an orthogonal longitudinal sectional view of the main body tube shown in FIG. 3;

FIG. 5 is a side view showing an operating tube in FIGS. 1 and 2;

FIG. 6 is a left side view of the operating tube shown in FIG. 5;

FIG. 7 is a view as seen in an arrow direction at a line VII-VII in FIG. 6;

FIG. 8 is a perspective view along a line VIII-VIII in FIG. 6;

FIG. 9 is a side view showing the movable body in FIGS. 1 and 2;

FIG. 10 is a view as seen in an arrow direction at a line X-X in FIG. 9;

FIG. 11 is a perspective view of the movable body shown in FIG. 9

FIG. 12 is a longitudinal sectional perspective view of the movable body shown in FIG. 11;

FIG. 13 is a perspective view showing a thread tube in FIGS. 1 and 2;

FIG. 14 is a longitudinal sectional perspective view of the thread tube shown in FIG. 13;

FIG. 15 is a perspective view of a click spring member in FIGS. 1 and 2 as seen from the rear;

FIG. 16 is a perspective view of the click spring member shown in FIG. 15 as seen from the side;

FIG. 17 is a longitudinal sectional perspective view showing a filling member in FIGS. 1 and 2;

FIG. 18 is an exploded perspective view showing an assembling procedure of the applying filler extruding container shown in FIG. 1;

FIGS. 19(a), 19(b) and 19(c) are explanatory views showing a change of state of an applying body and the applying filler on the basis of use of the applying filler extruding container shown in FIGS. 1 and 2;

FIG. 20 is a longitudinal sectional perspective view of a rear end portion of the applying filler extruding container, to show another example of a shaft body wrench-off preventing mechanism in FIGS. 1 and 2;

FIG. 21 is a perspective view showing another example of the applying body in FIG. 17;

FIG. 22 is view showing further another example of the applying body in FIG. 17, with an explanation to show a change of state of the applying body and the applying filler on the basis of use;

FIG. 23 is a longitudinal sectional view of the applying filler extruding container showing further another example of the filling member and the applying body shown in FIG. 17;

FIG. 24 is a longitudinal sectional view of the applying filler extruding container showing further another example of the filling member and the applying body shown in FIG. 17;

FIG. 25 is a view showing a state that the movable body of the applying filler extruding container shown in FIG. 24 is at a maximum forward moving time;

FIG. 26 is a perspective view showing an elastic body within the container in FIGS. 24 and 25;

### BEST MODE FOR CARRYING OUT THE INVENTION

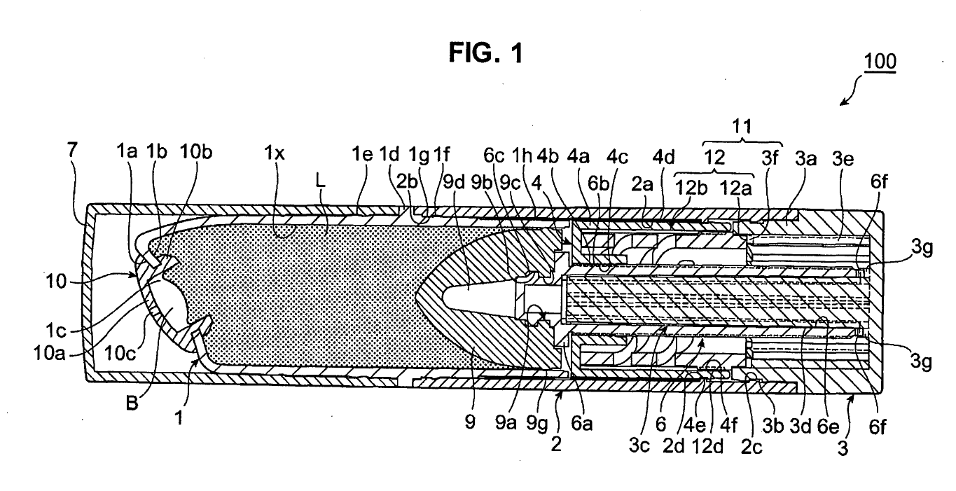

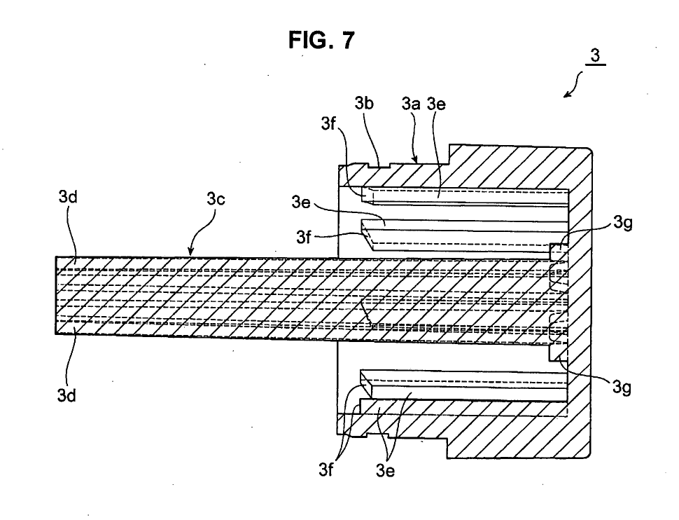

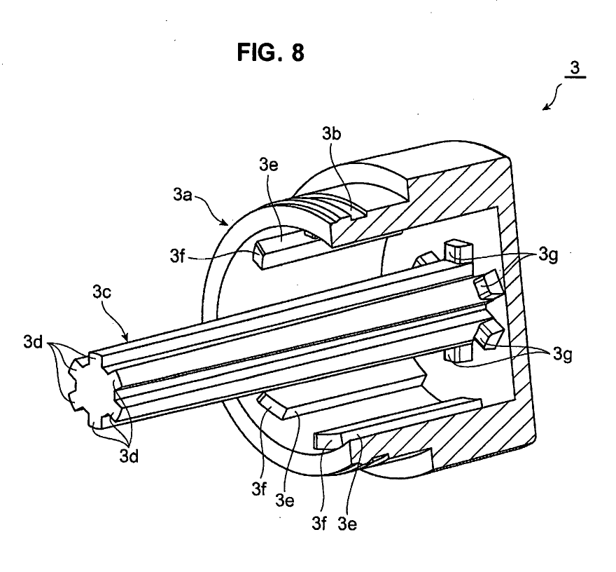

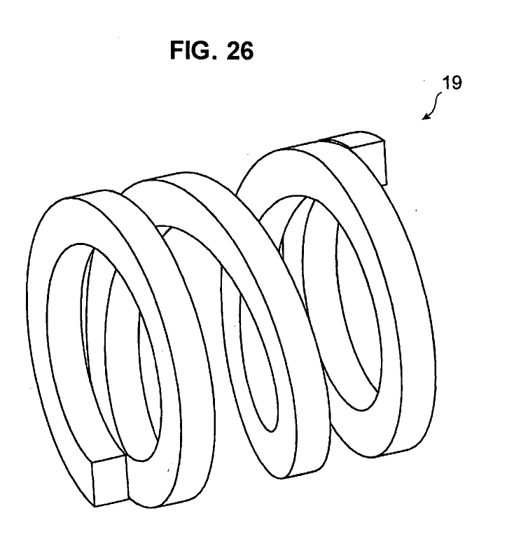

A description will be given of a preferable embodiment of an applying filler extruding container in accordance with the present invention with reference to FIGS. 1 to 26. In this case, each of the drawings, the same reference numerals are attached to the same elements and an overlapping description will be omitted.

The applying filler extruding container in accordance with the present embodiment can appropriately receive and extrude the applying filler on the basis of an operation of a user.

In this case, a lip gloss is employed as a particularly preferable example of the applying filler, however, the applying filler is not limited to this, but can be a liquid, a kneaded semisolid including a jelly and a paste, and a solid and the like, such as a lip color, an eye color, an eye liner, an essence, a cleaning solvent, a nail enamel, a nail care liquid solution, a nail enamel remover, a mascara, an anti-aging, a hair color, a hair cosmetic, an oral care, a massage oil, a keratotic plugging reducer, a foundation, a concealer, a skin cream, an ink for a writing instrument including a marking pen, a liquid medicine, a slurry and the like. It is particularly preferable for achieving the present invention to employ the applying filler having a high viscosity.

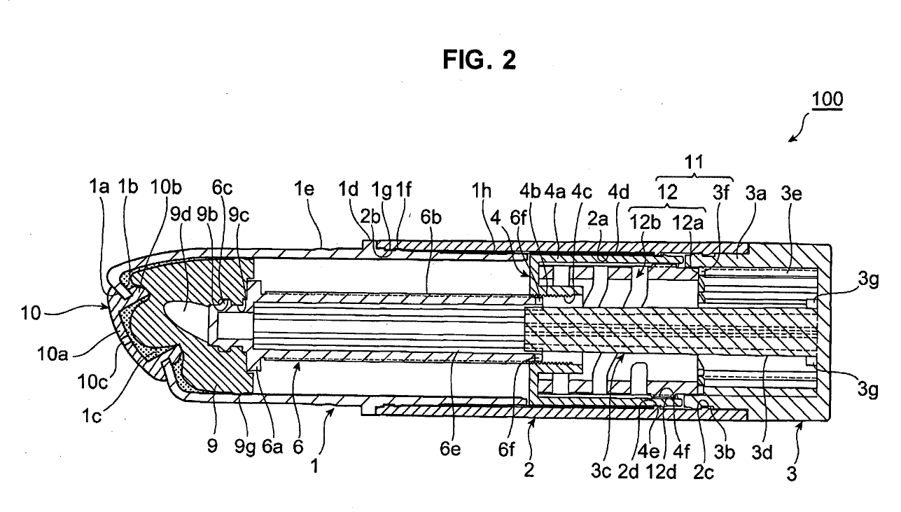

As shown in FIGS. 1 and 2, an applying filler extruding container 100 is provided with a filling member 1 corresponding to a leading tube having in an inner portion a filling region 1x in which an applying filler L is filled, a main body tube 2 coupling the filling member 1 so as to be non-rotatable and immobile in an axial direction in a state in which a rear half portion of the filling member 1 is inserted into a front half portion thereof, an operating tube (a rear portion of the container) 3 coupled to a rear end portion of the main body tube 2 so as to be relatively rotatable and immobile in the axial direction, and an applying body 10 constituting a leading end portion of the filling member 1 and provided for applying the applying filler L, as an outer structure. Further, an inner side of the container is generally provided with a movable body 6 having an elastic body 9 in a leading end portion and moving forward and backward in the axial direction by relatively rotating the main body tube 2 or the filling member 1 and the operating tube 3, a thread tube (a tubular body) 4 serving as an engagement mechanism which can move the movable body 6 on the basis of the relative rotation, and a click mechanism 11 giving a click feeling in synchronous with the relative rotation in forward and reverse directions.

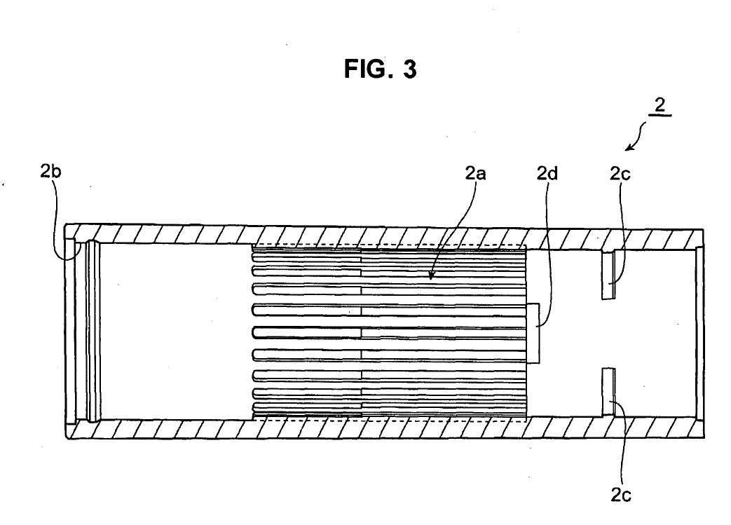

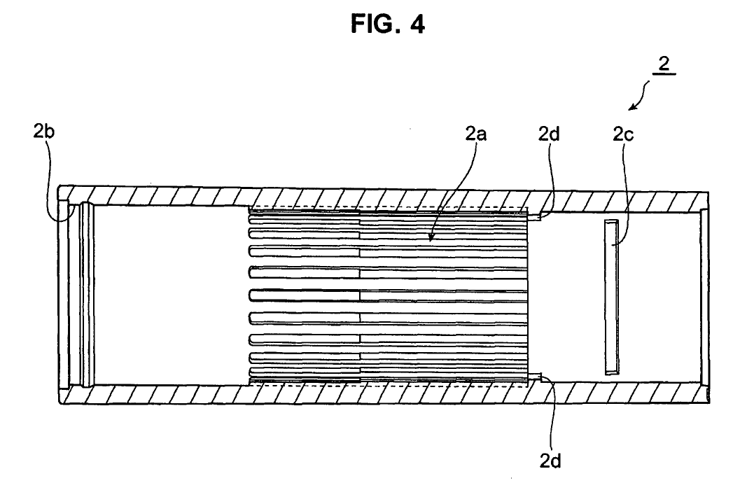

As shown in FIGS. 3 and 4, the main body tube 2 is structured in a cylindrical shape, and has a knurling 2a, which is provided with a lot of concavities and convexities in parallel in a peripheral direction and in which the concavities and convexities extend at a predetermined length in an axial direction, in an inner peripheral surface of a center portion in an axial direction thereof. The knurling 2a is provided such that a front half portion thereof engages the filling member 1 in a rotating direction, and a rear half portion engages the thread tube 4 in the rotating direction. Further, an annular protruding portion 2b for engaging the filling member 1 in an axial direction is provided in an inner peripheral surface of a leading end portion of the main body tube 2. Further, two protruding portions 2c extending in a circular arc shape along a peripheral direction are formed in an inner peripheral surface in a rear portion side of the main body tube 2, and two protruding portions 2d extending in a circular arc shape along a peripheral direction are formed at a front side position from the circular arc shaped protruding portion 2c. The circular arc shaped protruding portion 2c is provided for engaging the operating tube 3 in the axial direction, and the circular arc shaped protruding portion 2d is provided for engaging the thread tube 4 in the axial direction. The circular arc shaped protruding portion 2c and the circular arc shaped protruding portion 2d are provided at positions which do not overlap in the axial direction.

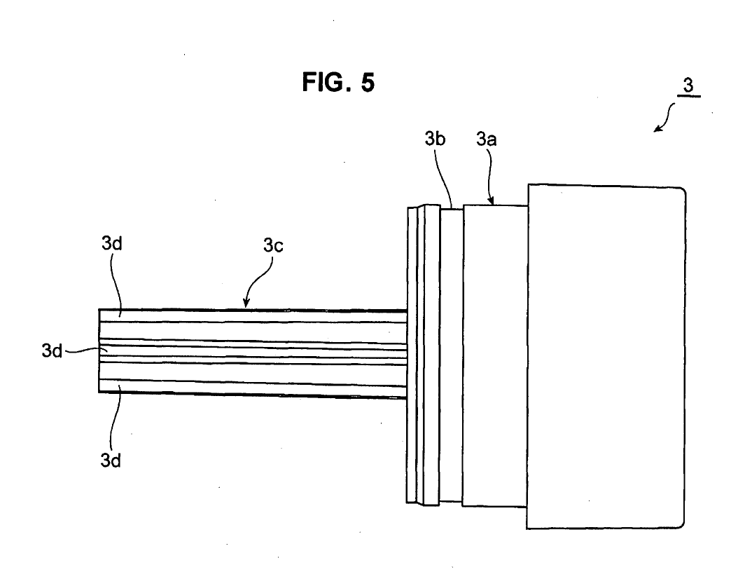

The operating tube 3 is structured in a closed-end cylindrical shape as shown in FIGS. 5 to 8, is provided with a leading end tube portion 3a having a small outer diameter in a leading end side, and is provided with an annular groove portion 3b for engaging with the circular arc shaped protruding portion 2c of the main body tube 2 in the axial direction, as shown in FIGS. 5, 7 and 8, in an outer peripheral surface of the leading end tube portion 3a.

A shaft body (a protruding portion) 3c is provided in a rising manner in a center of a bottom portion in the operating tube 3 so as to extend toward a leading end side, as shown in FIGS. 5 to 8. The shaft body 3c is formed in a non-circular shape in cross section provided with protrusions (an engagement portion) 3d arranged so as to protrude in a radial direction at six equal positions along a peripheral direction on an outer peripheral surface of a columnar body and extending in an axial direction, and the protrusions 3d are formed as a rotation prevention constituting one side of rotation preventing mechanisms (rotation preventing portions) of the movable body 6.

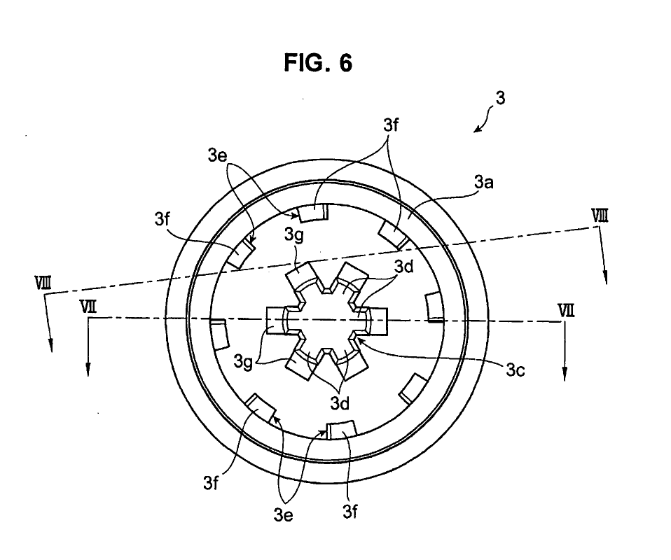

Further, as shown in FIGS. 6 to 8, the operating tube 3 is provided with protrusions 3e extending toward a leading end side from a bottom portion at eight equal positions along the peripheral direction, in an inner peripheral surface thereof. In the protrusion 3e, a leading end portion 3f is formed as a predetermined engagement portion constituting a click mechanism 11. Further, in the present embodiment, a leading end surface of the leading end portion 3f of the protrusion 3e is formed as an inclined surface inclined in one direction.

Further, a peripheral edge of the shaft body 3c in a bottom surface of the operating tube 3 is provided with a protruding portion 3g protruding short to the leading end side and formed as a protrusion for engaging with the movable body 6 in a rotating direction at the maximum retreated time of the movable body 6. The protruding portion 3g structures one side of shaft body wrench-off preventing mechanisms for preventing the shaft body 3c from being wrenched off at a time when an excessive rotating force is applied to the shaft body 3c, and is provided so as to be connected to a rear end portion of each of the protrusions 3d of the shaft body 3c.

The operating tube 3 is inside inserted to the main body tube 2 from the leading end tube portion 3a as shown in FIGS. 1 and 2, a step surface between the leading end tube portion 3a and a closed-end portion in a rear side thereof is brought into contact with a rear end surface of the main body tube 2, and the annular groove portion 3b engages with the circular arc shaped protruding portion 2c of the main body tube 2, thereby the operating tube 3 being attached to the main body 2 so as to be rotatable and immobile in the axial direction.

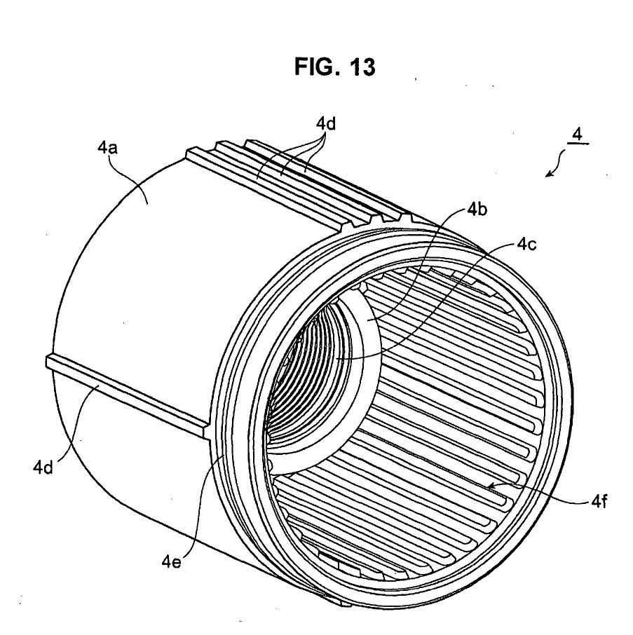

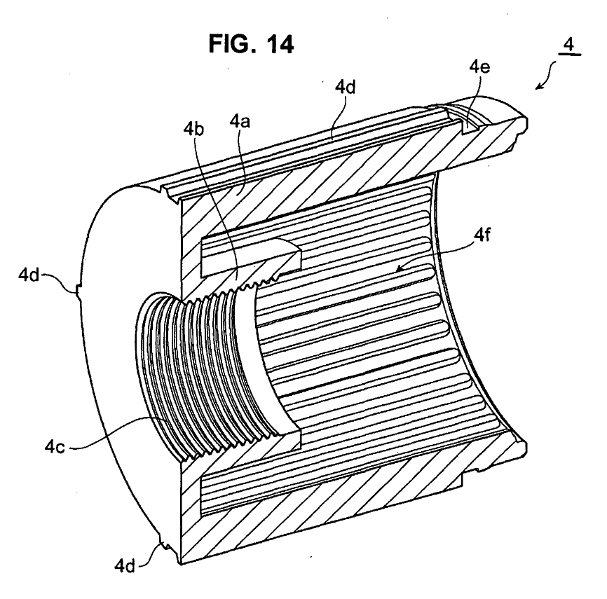

The thread tube 4 is formed in such a shape that an inside cylindrical tubular body 4b is connected to a leading end side of an outer cylindrical tubular body 4a, as shown in FIGS. 13 and 14, and is provided with a female thread 4c structuring one side of engagement mechanisms (engagement portions) in an inner peripheral surface of the inside tubular body 4b. A protrusion 4d for engaging with the knurling 2a of the main body tube 2 in the rotating direction is formed from a leading end to a rear end portion at a plurality of positions in the peripheral direction, on an outer peripheral surface of the outer tubular body 4a structuring the thread tube 4, and an annular groove portion 4e for engaging with the circular arc shaped protruding portion 2d of the main body tube 2 in the axial direction is formed at a position close to the rear end surface. Further, an inner peripheral surface of the outer tubular body 4a is provided with a knurling 4f in which a lot of concavities and convexities are provided in parallel and the concavities and convexities extend in an axial direction. The knurling 4f is provided for engaging a click spring member 12 constituting the click mechanism 11 in a rotating direction.

The thread tube 4 is inside inserted to the main body tube 2 from a rear end portion thereof as shown in FIGS. 1 and 2, the annular groove portion 4e is engaged with the circular arc shaped protruding portion 2d of the main body tube 2, and the protrusion 4d is engaged with the knurling 2a of the main body tub 2, thereby the thread tube 4 being attached to the main body tube 2 so as to be no-rotatable and immobile in the axial direction.

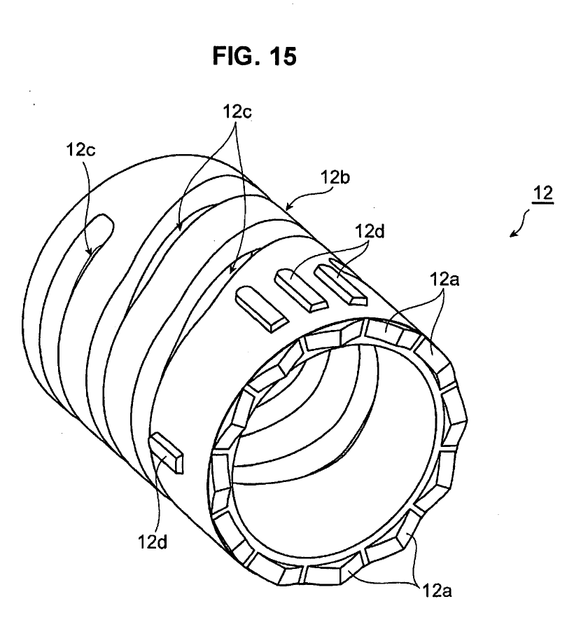

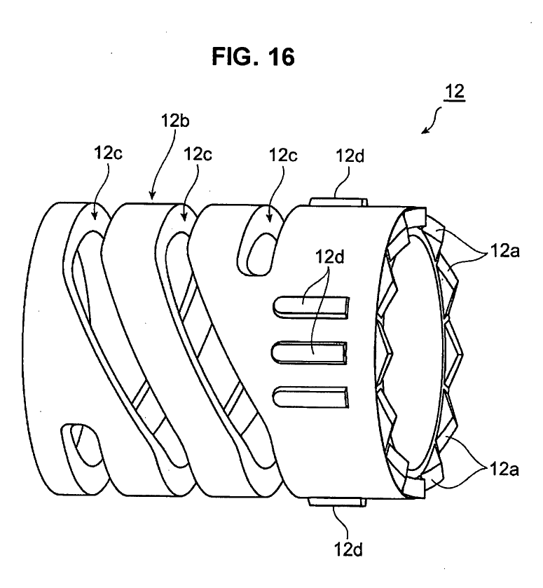

The click spring member 12 constitutes a rotating amount regulating member, and is formed as an injection molded product by a resin. The click spring member 12 is structured approximately in a cylindrical shape as shown in FIGS. 15 and 16, and is integrally formed in a rear end surface thereof so as to have click teeth 12a in which concavo-convex portions engaging with the leading end portions 3f of the protrusions 3e of the operating tube 3 are provided along a peripheral direction, and have a compression spring portion 12b serving as an elastic portion connecting to a rear end portion having the click teeth 12a. The click tooth 12a is structured in a chevron shape having an ascending incline and a descending incline along the peripheral direction. Further, the compression spring portion 12b is provided with an approximately spiral slit 12c in a peripheral wall thereof, and energizes the pressed click teeth 12a against the pressing force by the slit 12c. Further, a plurality of protrusions 12d for engaging with the knurling 4f of the thread tube 4 in the rotating direction are provided in an outer peripheral surface of a rear end portion of the click spring member 12 along the peripheral direction.

In the click spring member 12, as shown in FIGS. 1 and 2, the leading end portion is received in the thread tube 4 so as to be positioned between the outer tubular body 4a and the inner tubular body 4b of the thread tube 4, and the protrusions 12d are engaged with the knurlings 4f of the thread tube 4, whereby the click spring member 12 is set non-rotatable with respect to the thread tube 4. In this state, the click spring member 12 is arranged so as to be pinched between a back face of the leading end portion connecting the outer and inner tubular bodies 4a and 4b of the thread tube 4 and the leading end portions 3f of the protrusions 3e of the operating tube 3. Further, the click teeth 12a of the click spring member 12 are energized to a rear side by the compression spring portion 12b, and is set in a click engagement state with respect to the leading end portions 3f of the protrusions 3e of the operating tube 3.

In this case, the shapes of the click tooth 12a of the click spring member 12 and the leading end portion 3f of the protrusion 3e of the operating tube 3 engaged by click therewith are not limited to those mentioned above, but may employ other shapes as far as the click engagement is achieved by the relative rotation in the forward and reverse directions.

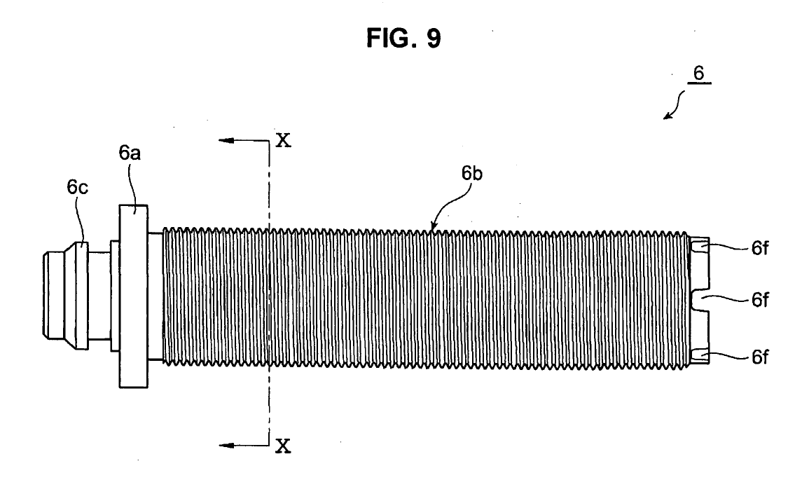

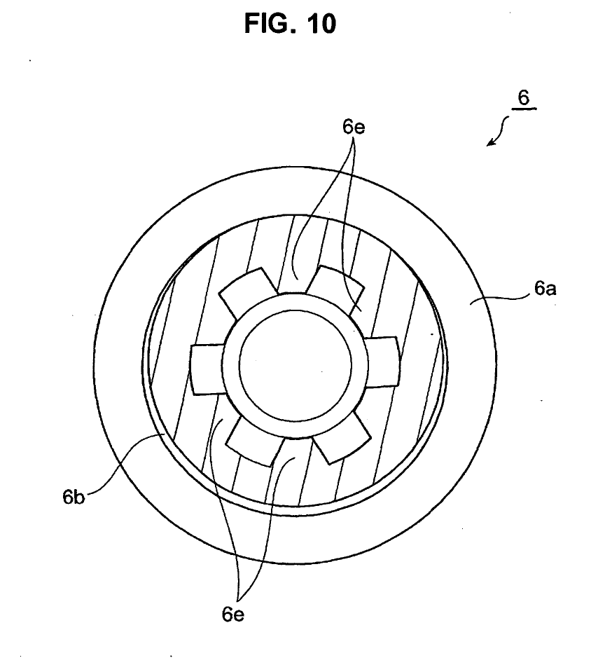

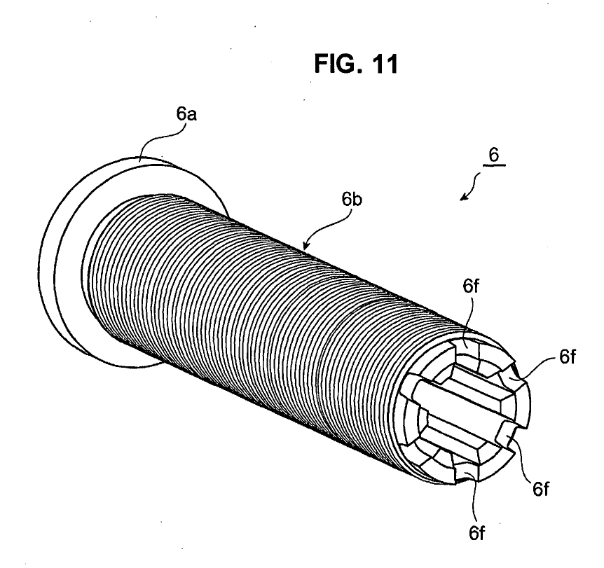

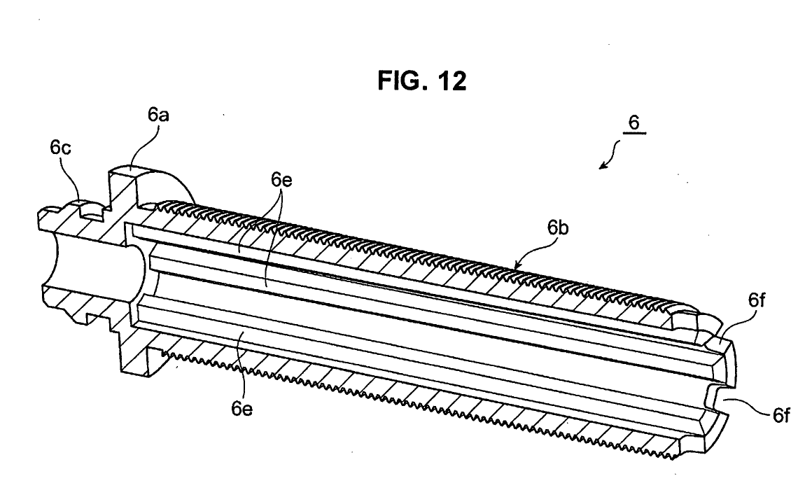

The movable body 6 is structured in the cylindrical shape having a collar portion 6a in a leading end side, as shown in FIGS. 9 to 12, and is provided with a male thread 6b constituting the other side of the engagement mechanisms (the engagement portions) in an outer peripheral surface extending to a rear end portion from a rear side of the collar portion 6a. Further, an annular protruding portion 6c for engaging the elastic body 9 in an axial direction is formed in an outer peripheral surface of a front side of the collar portion 6a of the movable body 6, as shown in FIGS. 9 and 12. Further, as shown in FIG. 12, an inner peripheral surface reaching a rear end from the periphery of the collar portion 6a of the movable body 6 is provided with protrusions 6e arranged so as to protrude to an inner side in a radial direction and extending in the axial direction, at six equal positions along the peripheral direction, as shown in FIGS. 10 and 12, and the protrusions 6e are formed as the rotation prevention constituting the other side of the rotation preventing mechanism (the rotation preventing portion) of the movable body 6. Further, a rear end surface of the movable body 6 is provided with grooves 6f serving as a concave portion concaved short to the leading end side and communicating the inner and outer sides of the movable body 6, at six equal positions along the peripheral direction, as shown in FIGS. 11 and 12. The grooves 6f constitute the other side of the shaft body wrench-off preventing mechanisms, and move forward to the protruding portion 3g of the operating tube 3 and engages in the rotating direction at the maximum retreated time of the movable body 6.

The movable body 6 is outside inserted to the shaft body 3c of the operating tube 3 from the rear end portion thereof and is inside inserted to the tubular body 4b in the inner side of the thread tube 4, as shown in FIGS. 1 and 2. In a state in which the male thread 6b is engaged with the female thread 4c of the thread tube 4, the protrusion 6e is engaged with a portion between the protrusions 3d and 3d of the shaft body 3c and is attached to the operating tube 3 so as to be non-rotatable and movable in the axial direction.

The elastic body 9 is formed by a soft elastic material which tends to be elastically deformed, for example, a silicone rubber or the like. In addition to the silicone rubber, it is possible to select a thermosetting raw material in accordance with compression molding such as a nitrile rubber (NBR), an ethylene propylene rubber (EPR), a butyl rubber (IIR) and the like, and a thermoplastic raw material in accordance with an injection molding such as a polyurethane-based elastomer (TPU), a polyolefin-based elastomer (TPO), a polyester-based elastomer (TPEE) and the like.

The elastic body 9 is formed in a bell shape tapered toward a leading end, as shown in FIG. 1, is provided with a stepped concave portion 9a extending at a predetermined length toward a leading end side from the rear end surface, and has an annular groove portion 9b and an annular protruding portion 9c for engaging with the annular protruding portion 6c of the movable body 6 in the axial direction, in a rear portion side of the concave portion 9a. Further, the elastic body 9 is provided in an outer peripheral surface of a rear end portion with an annular protruding portion 9g closely attached to the inner peripheral surface of the filling member 1 for securing water tightness.

The elastic body 9 is outside inserted to the movable body 6 from a rear portion side thereof, the rear end surface is brought into contact with the leading end surface of the collar portion 6a of the movable body 6, and the annular groove portion 9b and the annular protruding portion 9c are engaged with the annular protruding portion 6c of the movable body 6, whereby the elastic body 9 is attached to the movable body 6 so as to be rotatable and immobile in the axial direction. In this state, a space 9d for promoting elastic deformation of the elastic body 9 is defined in a front half side within the elastic body 9, by the leading end portion of the movable body 6 moving forward into the concave portion 9a. Dimensions, an arrangement and the like of the elastic body 9 are set such that the elastic body 9 reaches the rear end portion of the applying body 10 in the leading end of the filling member 1 in the case that the movable body 6 moves forward to the maximum.

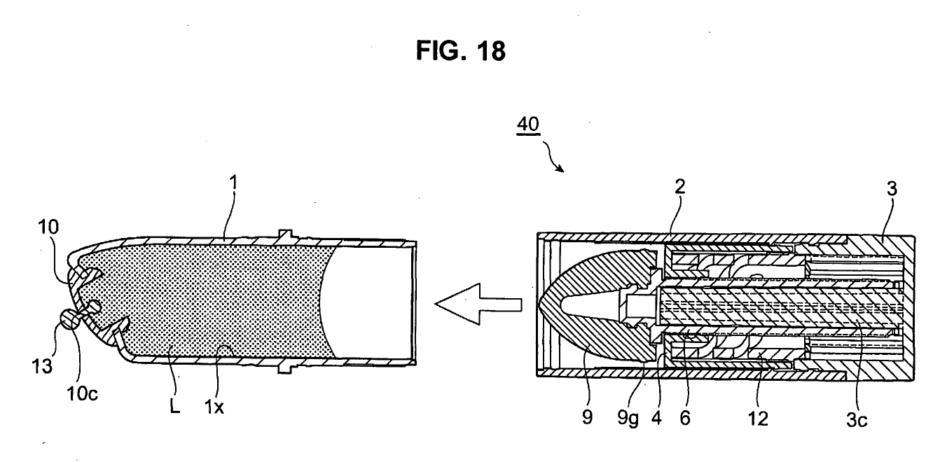

Further, the engagement mechanism is constituted by the male thread 6b of the movable body 6 and the female thread 4c of the thread tube 4, the rotation preventing mechanism is constituted by the protrusions 6e of the movable body 6 and the protrusions 3d of the shaft body 3c, the click mechanism 11 is constituted by the click teeth 12a and the compression spring portion 12b of the click spring member 12, and the leading end portions 3f of the protrusions 3e of the operating tube 3, and the extruding mechanism of the applying filler L constituted by them, the movable body 6 and the elastic body 9 are installed in the main body side tube body comprising the main body tube 2 and the operating tube 3, whereby the main body side assembly 40 is structured (refer to FIG. 18).

The filling member 1 is provided for filling the applying filler L in the inner filling region 1x, and is provided for discharging the applying filler L from the leading end portion in accordance with the operation by a user. It is preferable that the material of the filling member 1 is constituted by an injection molded plastic such as a polyethylene terephthalate (PET), a polypropylene (PP) or the like, and it is preferable that the material is constituted by a transparent material for checking out a color tone and a filling condition of the applying filler L.

The filling member 1 is formed in a cylindrical shape as shown in FIGS. 1, 2 and 17, and an outer surface 1a of the leading end portion is formed as an inclined surface inclined in a predetermined direction. Further, an inner surface 1b formed as an inclined surface is formed in the leading end portion of the filling member 1 at a distance of a fixed thickness with respect to the outer surface 1a, and an opening 1c communicating the inner surface 1b with the outer surface 1a is provided.

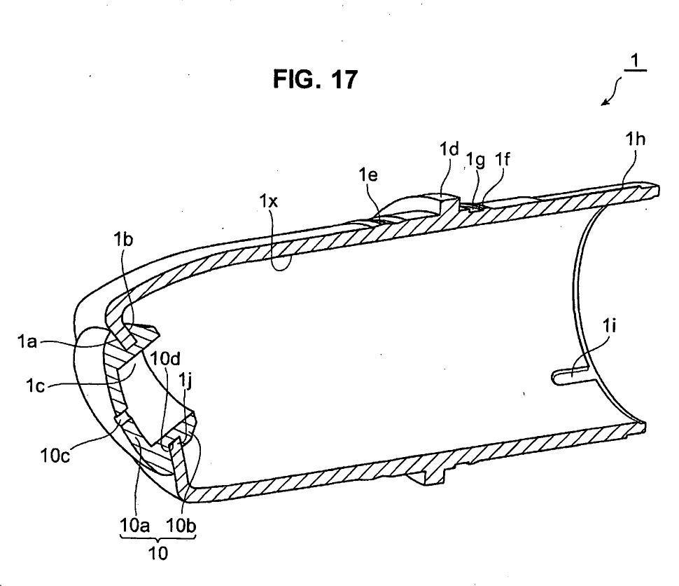

Further, an outer peripheral surface of the filling member 1 is provided with a collar portion 1d in which an outer diameter is made large so as to be brought into contact with an open end in a leading end side of the main body tube 2, approximately in a center portion in the axial direction, and an annular protruding portion 1e for detachably locking a cap 7 (refer to FIG. 1) covering a front side of the collar portion 1d of the filling member 1 in the axial direction is provided at a front position close to the collar portion 1d. Further, the annular groove portion 1g and the annular protruding portion 1f for being engaged with the annular protruding portion 2b of the main body tube 2 in the axial direction are provided in parallel in the axial direction, at a rear position close to the collar portion id, on the outer peripheral surface of the filling member 1, and protrusions 1h extending in an axial direction are respectively formed at four equal positions in the peripheral direction, in the position of the rear end portion. The protrusion 1h is provided for being engaged with the knurling 2a of the main body tube 2 in the rotating direction. Further, as shown in FIG. 17, an air vent groove 1i open to a rear side and extending short toward the leading end side is provided in an inner peripheral surface of the rear end portion of the filling member 1.

The filling member 1 is inside inserted to the main body tube 2 from a rear portion side thereof, a rear end surface of the collar portion 1d is brought into contact with an open end in a leading end side of the main body tube 2 as shown in FIGS. 1 and 2, the annular groove portion 1g and the annular protruding portion 1f are engaged with the annular protruding portion 2b of the main body tube 2, and the protrusion 1h is engaged with the knurling 2a of the main body tube 2, whereby the filling member 1 is attached to the main body tube 2 so as to be non-rotatable and immobile in the axial direction, and is integrally formed with the main body tube 2. Further, the cap 7 is attachable to the filling member 1 as shown in FIG. 1.

The filling member 1 is provided with the applying body 10 for applying the applying filler L in the leading end portion, as shown in FIGS. 1, 2 and 17. The applying body 10 is constituted by an elastic body made of a rubber material, an elastomer material or the like, and is provided with a curved disc-shaped applying portion 10a curved in such a manner that a portion near a center portion protrudes, and an annular attaching portion 10b continuously provided so as to protrude to a back surface in a peripheral edge side of the applying portion 10a, as shown in FIG. 17.

The applying portion 10a is provided with a discharge port 10c communicating an inner surface with an outer surface and formed for discharging the applying filler L, and the attaching portion 10b is provided with an annular groove portion 10d concaved to an axial side in an outer peripheral surface at a root position close to the applying portion 10a, as a structure engaging with the peripheral edge portion 1j forming the opening 1c of the filling member 1.

The applying body 10 is inside inserted to the opening 1c of the filling member 1 in such a manner that the attaching portion 10b is deflected to an axial side, and is structured, as shown in FIGS. 1 and 2, such that a rear end portion of the attaching portion 10b moves forward into the filling member 1 and the annular groove portion 10d is engaged with the peripheral edge portion 1j forming the opening 1c of the filling member 1, whereby the applying body 10 is attached to the filling member 1 so as not to be disengaged and is positioned in the opening 1c. The applying portion 10a of the applying body 10 is elastically deformed so as to be concaved to a rear side by being pressed to the applied portion, and is elastically restored to the original position by being moved apart from the applied portion.

In the case of assembling the applying filler extruding container 100 having the structure mentioned above, the main body side assembly 40 shown in FIG. 18 is obtained by mounting the click spring member 12 in the operating tube 3 so as to be received, screwing the thread tube 4 into the leading end portion of the movable body 6, attaching the elastic body 9 to the leading end of the movable body 6, coupling the movable body 6 having the elastic body 9 and the thread tube 4 to the shaft body 3c of the operating tube 3, and pressing and attaching the main body tube 2 to the assembly.

On the other hand, in the filling member 1, in a state in which the discharge port 10c of the applying body 10 is closed by a stop plug 13 so as to be reversed, a predetermined amount of applying filler L is filled in the filling region 1x so as to form no space within the leading end of the filling member 1. Further, the filling member 1 filled with the applying filler L is inserted to and attached to the leading end side of the main body side assembly 40. At this time, since an inner peripheral surface of the filling member 1 is set at an initial position while being in slidable contact with the annular protruding portion 9g for securing a water tightness of the elastic body 9, and the air vent groove 1i in the inner peripheral surface thereof is positioned so as to come across the annular protruding portion 9g in the axial direction, the air in the applying filler side is well vented to the rear side through the air vent groove 1i. Further, the stop plug 13 is detached finally. In this case, in place of the stop plug 13, a seal which can be detached after filling and just before the user uses and to which an adhesive agent is applied, may be attached to the discharge port 10c of the applying body 10 before the filling of the applying filler L.

In accordance with the applying filler extruding container 100 structured as mentioned above, since the filling member 1 filled with the applying filler L is structured such as to be inserted and attached to the leading end side of the main body side assembly 40, it is easy to assemble after filling the applying filler L in the filling member 1, and the applying filler L is in a state of being sufficiently (fully) filled in the filling region 1x between an inner side of the discharge port 10c of the applying body 10 constituting the leading end portion of the filling member 1 and the elastic body 9 attached to the leading end of the movable body 6 of the main body side assembly 40.

Next, a description will be given of a use of the applying filler extruding container 100 structured in the manner mentioned above. In the applying filler extruding container 100, if the main body tube 2 or the filling member 1 and the operating tube 3 are relatively rotated by a user, the movable body 6 moves forward and backward by the engaging mechanism and the rotation preventing mechanism mentioned above, and the leading end portion 3f of the protrusion 3e in the operating tube 3 constituting the click mechanism 11 mentioned above and the click tooth 12a of the click spring member 12 energized to the leading end portion 3f repeat the click engagement in accordance with the relative rotation at this time. Accordingly, the click feeling is given to the user, and a forward moving degree and a returning degree of the movable body 6 are detected on the basis of the click feeling.

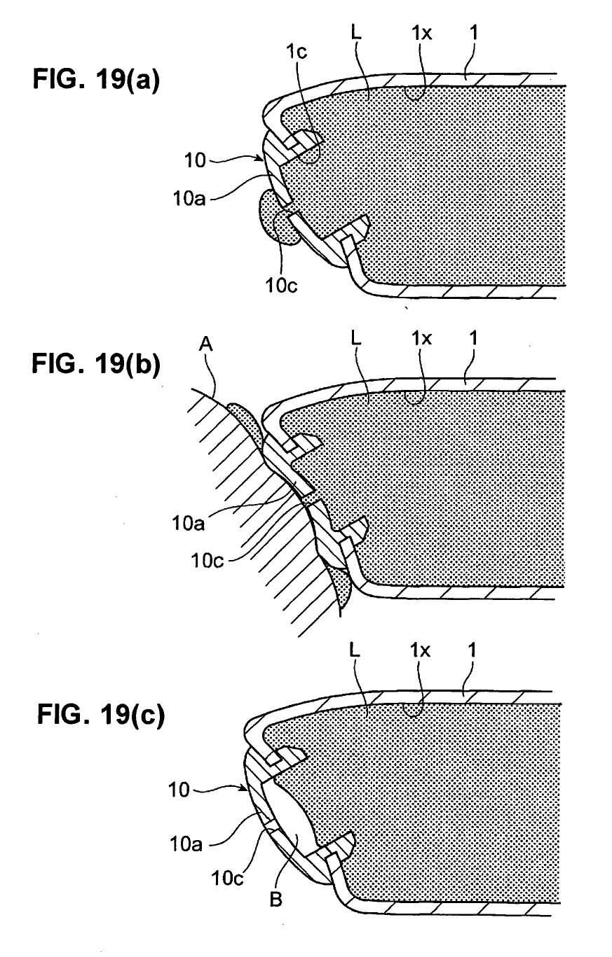

Further, if the user relatively rotates the main body tube 2 or the filling member 1 and the operating tube 3 so as to move the movable body 6 forward while accompanying with the click feeling, at the first applying time after buying the applying filler extruding container 100, the applying filler L is rapidly (immediately) discharged from the discharge port 10c of the applying body 10 as shown in FIG. 19(a) without repeating the relative rotation more than necessary, because the applying filler L is sufficiently filled in the filling region 1x between the inner side of the discharge port 10c of the applying body 10 constituting the leading end portion of the filling member 1 and the elastic body 9 of the movable body 6 of the main body side assembly 40, as mentioned above. Accordingly, there is provided the applying filler extruding container 100 in which customer satisfaction is improved.

The user presses the applying portion 10a of the applying body 10 to the applied portion A so as to apply the applying filler L to the applied portion A in this state, as shown in FIG. 19(b). At this time, the applying portion 10a of the applying body 10 is elastically deformed so as to be concaved (collapsed) to the rear side on the basis of the pressing to the applied portion A. Since the applying portion 10a of the applying body 10 is elastically deformed as mentioned above, a feeling given to the applied portion A such as a skin or the like is soft and good. Further, since the applying portion 10a of the applying body 10 is pressed and collapsed, an internal pressure is increased, the applying filler L is discharged at a proper amount, and a use amount is secured.

Further, if the application is finished, and the applying body 10 is moved apart from the applied body A, the applying portion 10a of the applying body 10 is elastically restored to the original position (refer to FIG. 19(a)) as shown in FIG. 19(c). At this time, a predetermined space B is formed in an inner side including the discharge port 10c of the applying portion 10a in the applying body 10.

Accordingly, even if the applying filler L filled in the filling region 1x of the filling member 1 and the air mixing into the applying filler L is expanded due to variation of temperatures or variation of atmospheric pressure at a time of not being used such as a carrying time or the like, the applying filler L is prevented from leaking from the applying body 10 on the basis of the predetermined space B. Accordingly, it is possible to provide the applying filler extruding container 100 having an improved quality.

In this case, in the assembling procedure of the applying filler extruding container 100 described in FIG. 18, if the applying filler L of the filling region 1x is filled in a state in which the applying portion 10a of the applying body 10 is concaved, the applying portion 10a of the applying body 10 is elastically returned after the application so as to make the applying filler extruding container 100 in which the predetermined space B is formed upon filling of the applying filler L. Accordingly, the applying filler L is prevented from leaking from the applying body 10, since this time point, that is, since the time when the product is assembled.

Further, in accordance with the applying filler extruding container 100 on the basis of the present embodiment, as shown in FIG. 2, if the movable body 6 reaches the front to the maximum on the basis of the relative rotation between the main body tube 2 or the filling member 1 and the operating tube 3 by the user, the elastic body 9 is brought into contact with the rear end portion of the attaching portion 10b of the applying portion 10 attached to the leading end portion of the filling member 1, and is elastically deformed on the lines of the rear end portion inclined in the circular ring shape. At this time, the elastic body 9 is elastically deformed more preferably on the basis of the space 9d within the elastic body 9. Further, the applying filler L leaving in an approximately hoof-shaped (oblique circular cylindrical) space (a space including an inclined surface within the container leading end), which cannot be pressed out by the conventional movable body, is sufficiently pressed out with almost no remainder so as to be consumed, on the basis of the elastic deformation of the elastic body 9 mentioned above. Accordingly, there is provided an economic applying filler extruding container 100 in which a waste is reduced.

Further, in accordance with the applying filler extruding container 100, since the structure is made such that the annular groove portion 1g corresponding to the locking portion of the outer peripheral surface of the filling member 1 and the annular protruding portion 2b corresponding to the locking portion between the annular protruding portion 1f and the inner peripheral surface of the main body tube 2, and the protrusion 1h corresponding to the locking portion of the outer peripheral surface of the filling member 1 and the knurling 2a corresponding to the locking portion of the inner peripheral surface of the main body tube 2 are directly locked via no other member, it is possible to make the applying filler extruding container 100 thin. Accordingly, there is provided the applying filler extruding container 100 in which an appearance and a use feeling are improved.

Further, in accordance with the applying filler extruding container 100, the forward moving degree and the returning degree are detected by a user on the basis of the click feeling given to the user by the click mechanism 11. Accordingly, there is provided the applying filler extruding container 100 having an improved usability.

In this case, in the present embodiment, the movable body 6 moves backward, when the main body tube 2 or the filling member 1 and the operating tube 3 are relatively rotated in the other direction corresponding to the opposite direction to the one direction by a user with click feeling. Accordingly, if the relative rotating force intending to move further backward is given to the movable body 6 existing at the maximum retreated position by the user, there is a risk that the shaft body 3c engaging with the movable body 6 is wrenched off in the bottom surface of the operating tube 3. However, in the present embodiment, since a plurality of protruding portions 3g in the bottom surface of the operating tube 3 and a plurality of grooves 6f in the rear end surface of the movable body 6 are engaged in the rotating direction at the maximum backward moving time of the movable body 6, the rotating force intending to move the movable body 6 further backward and applied to the shaft body 3c is also applied to the protruding portion 3g of the operating tube 3 via the groove 6f of the movable body 6 so as to be dispersed, thereby preventing the shaft body 3 from being wrenched off. Accordingly, there is provided the applying filler extruding container 100 in which a quality is further improved.

In this case, the structure may be made such that concave portions are provided in place of the grooves 6f of the movable body 6 for preventing the shaft body 3c from being wrenched off, and the concave portions are engaged with the protruding portions 3g of the operating tube 3 in the rotating direction.

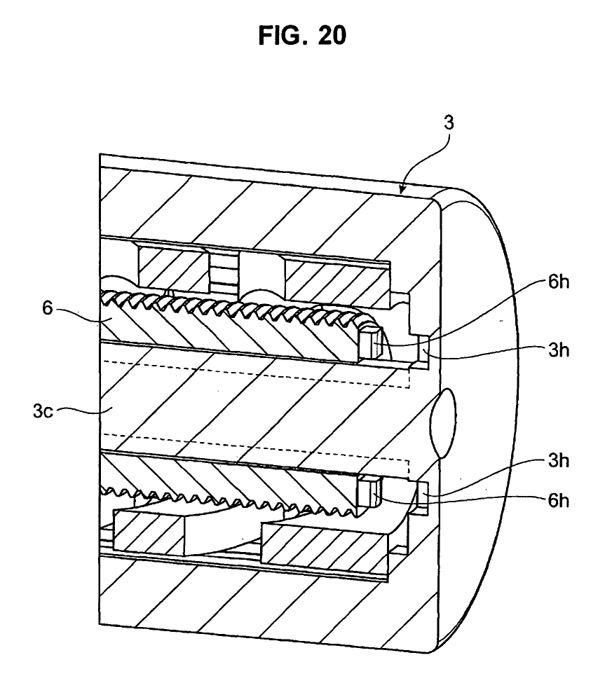

Further, as the other example of the shaft body wrench-off preventing mechanism, on the contrary of the shaft body wrench-off preventing mechanism mentioned above, as shown in FIG. 20, the structure may be made such that the convex portions 6h protruding to the rear side are provided at a plurality of positions along the peripheral direction in the rear end surface of the movable body 6, and a plurality of concave portions 3h which the convex portions 6h of the movable body 6 move forward into at the maximum retreated time of the movable body 6 and engage with in the rotating direction are provided in the peripheral edge of the shaft body 3c in the bottom surface of the operating tube 3.

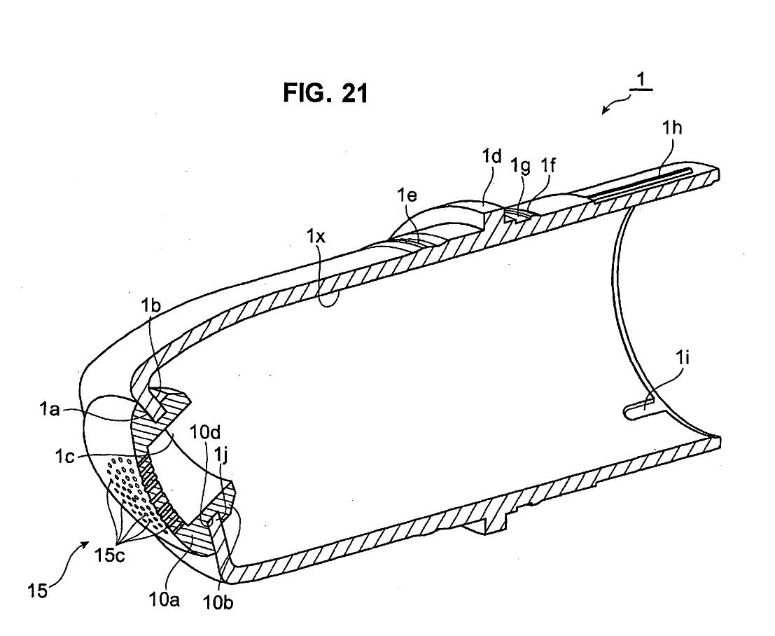

Further, in place of the applying body 10 shown in FIG. 17, an applying body 15 having a plurality of discharge ports 15c for discharging the applying filler L may be used as shown in FIG. 21.

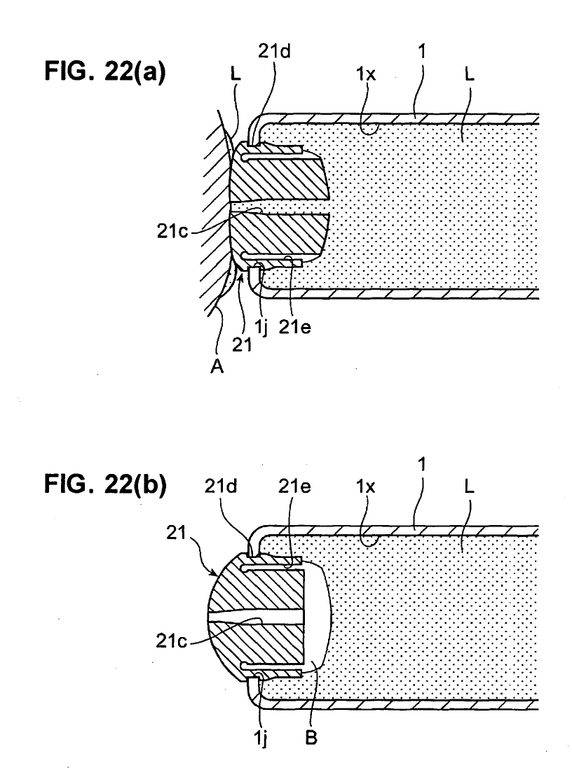

Further, an applying body 21 shown in FIG. 22 may be used in place of the applying body 10 shown in FIG. 17. The applying body 21 is formed in an approximately columnar shape, as shown in FIG. 22(b), and is structured such that a portion near a center portion of the leading end surface is curved so as to protrude. Further, a discharge port 21c for discharging the applying filler L is provided in the center thereof so as to pass through in an axial direction. Further, an annular groove portion 21e concaved at a predetermined length from a rear end surface to a leading end side is provided in a peripheral edge portion of a rear end surface of the applying body 21. The annular groove portion 21e is provided so as to deflect an outer portion from the annular groove portion 21e to an axial side so as to easily pressure insert, at a time of pressure inserting the applying body 21 to the opening of the filling member 1. Further, the annular groove portion 21d concaved to the axial side is provided as a structure engaging with the peripheral edge portion 1j forming the opening of the filling member 1, in an outer peripheral surface of the applying body 21.

Further, the applying body 21 is pressure inserted to the opening of the filling member 1, and the annular groove portion 21d thereof is engaged with the peripheral edge portion 1j forming the opening of the filling member 1, thereby being attached to the filling member 1 so as not to be disconnected, and being structured such as to be positioned in the opening of the filling member 1.

The applying body 21 is elastically deformed in such a manner as to be concaved to a rear side by being pressed to the applied portion A at a time of application, as shown in FIG. 22(a), and is elastically restored to the original position at a time of being apart from the applied portion A. As shown in FIG. 22(b), a predetermined space B is formed in an inner side (a rear side) of the applying body 21 after application. Accordingly, it is possible to obtain the same effect as that of the applying filler extruding container 100 as mentioned above. In this case, in the embodiment shown in FIG. 22, the leading end surface having the opening 1c of the filling member 1 is formed as a surface which is vertical to the axial direction.

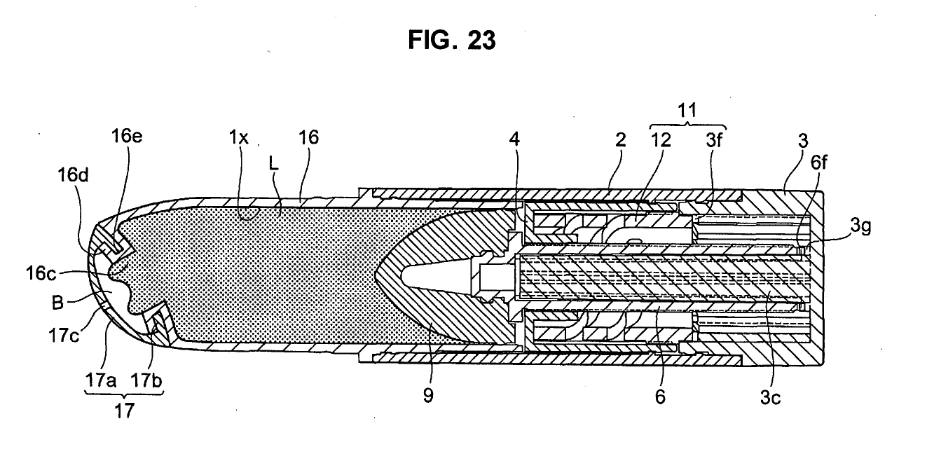

Further, a filling member 16 and an applying body 17 shown in FIG. 23 may be used. The filling member 16 is different from the filling member 1 in a point that the peripheral edge portion forming an opening 16c for discharging the applying filler L is structured such as to have an annular fold-back portion 16d folded back to an outer side, and a bag-shaped annular groove portion 16e for engaging the applying body 17 is formed by the annular fold-back portion 16d. Further, the applying body 17 is different from the applying body 10 in a point that an annular attaching portion 17b protruding to an axial side and a rear side is provided in a peripheral edge portion of a curved disc-shaped applying portion 17a having a discharge port 17c and curved to an outer side.

Further, the applying body 17 is structured such that an attaching portion 17b moves forward to the annular groove portion 16e of the filling member 16 so as to be engaged, thereby being attached to the filling member 16 so as not to be disconnected, and an applying portion 17a covers the opening 16c of the filling member 16. Even in the case that the filling member 16 and the applying body 17 are employed, the same operations and effects as those of the applying filler extruding container 100 mentioned above can be achieved.

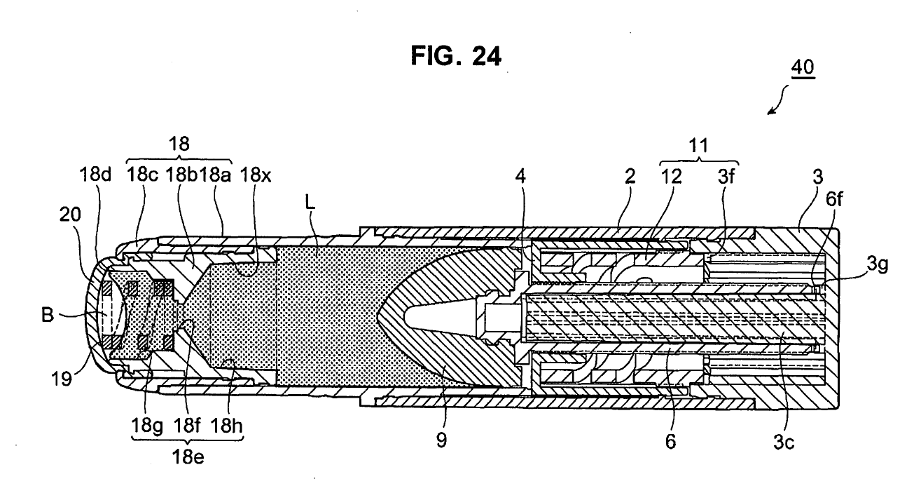

Further, as shown in FIGS. 24 to 26, the structure may be made such that the applying body 20 is elastically restored by an elastic body 19 within a filling member 18 constituting the container.

The filling member 18 is provided with a filling member main body 18a coupled to the main body tube 2 so as to be non-rotatable, and immobile in the axial direction, a filling member leading end portion 18b attached to a leading end portion of the filling member main body 18a, and an applying body holding portion 18c attached to the filling member leading end portion 18b and holding the applying body 20, and is entirely formed in an approximately cylindrical shape.

The filling member main body 18a receives most of the applying filler L to be filled. The filling member leading end portion 18b is structured such that a leading end surface having an opening 18d for discharging the applying filler L is formed as a surface vertical to the axial direction, and is provided with a discharge passage 18e communicating from the opening 18d in the leading end surface to a rear end surface. The discharge passage 18e is structured such that an approximately center portion in the axial direction is formed as a small-diameter narrow passage 18f, and a front side and a rear side of the narrow passage 18f are formed as large-diameter expanded passages 18g and 18h.

The applying body 20 is constituted by an elastic body made of a porous material, for example, an urethane foam, a fine net-like material or the like, and is formed in a curved disc shape curved to an outer side. A peripheral edge portion bent to a rear side in the applying body 20 is engaged with a leading end portion of the filling member leading end portion 18b and engaged with a leading end portion of the applying body holding portion 18c so as to be pressed, whereby the applying body 20 is attached to the filling member 18, and covers the opening 18d of the filling member 18.

Further, a compression spring 19 serving as the elastic body is arranged in a front side expanded passage 18g of the filling member leading end portion 18b. The compression spring 19 is arranged so as to be pinched between a back surface of the applying body 20 and a peripheral edge portion of the narrow passage 18f of the filling member leading end portion 18b, and is structured such as to always energize the applying body 20 to the outer side.

Further, since the applying filler extruding container having the structure mentioned above is structured such that the filling member 18 in which the applying filler L is filled is inserted and attached to the leading end side of the main body side assembly 40, it is easy to assemble after the applying filler L is filled in the filling member 18, and there is provided a state in which the applying filler L is sufficiently filled in a filling region 18x between an inner side of the applying body 20 constituting the leading end portion of the filling member 18, and the elastic body 9 attached to the leading end of the movable body 6 of the main body side assembly 40.

Accordingly, in the applying filler extruding container, in the case that the user relatively rotates the main body tube 2 or the filling member 18 and the operating tube 3 while accompanying the click feeling so as to move forward the movable body 6 at the first applying time after buying the applying filler extruding container, the applying filler L is rapidly discharged from the porous portion functioning as a discharge port of the applying body 20 without repeating the relative rotation more than necessary, because the applying filler L is sufficiently filled in the filling region 18x.

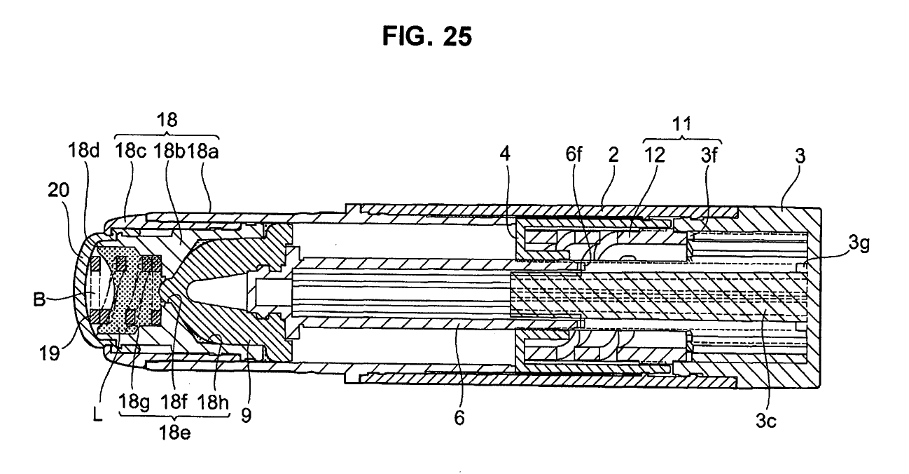

Further, when pressing the applying body 20 to the applied portion A and applying the applying filler L to the applied portion A in the same manner as described in FIG. 19(b) under the state in which the applying filler L is discharged as mentioned above, the applying body 20 is elastically deformed so as to be concaved to the rear side against the energizing force of the compression spring 19 on the basis of the pressing to the applied portion A. When the application is finished and the applying body 20 is moved apart from the applied portion A, the applying body 20 is elastically restored to the original position shown in FIG. 25 on the basis of the energizing force of the compression spring 19. The predetermined space B is formed in the inner side of the applying body 20 at this time. Accordingly, even if the applying filler L filled in the filling member 18 and the air mixing into the applying filler L are inflated due to the variation of temperature and the variation of atmospheric pressure, the applying filler L is prevented from leaking from the applying body 20 on the basis of the predetermined space B.

In this case, in the same manner as the case of the applying filler extruding container 100 mentioned above, if the applying filler L is filled in a state in which the applying body 20 is concaved, the applying body 20 is elastically returned on the basis of the energizing force of the compression spring 19 after the application so as to make the applying filler extruding container in which the predetermined space B is formed upon filling of the applying filler L. Accordingly, the applying filler L is prevented from leaking from the applying body 20, since this time point, that is, since the time when the product is assembled.

Further, as shown in FIG. 25, if the movable body 6 moves forward to the maximum on the basis of the relative rotation between the main body tube 2 or the filling member 18 and the operating tube 3 by the user, the elastic body 9 is brought into contact with the inclined surface in the leading end side of the rear side expanded path 18h so as to be elastically deformed, and the leading end portion of the elastic body 9 bulges so as to move forward to the front side expanded passage 18g through the narrow passage 18f. Accordingly, the applying filler L is well pressed out so as to be consumed. In this case, the other operations and effects are the same as those of the applying filler extruding container 100 mentioned above.

The description is particularly given above of the present invention on the basis of the embodiments, however, the present invention is not limited to the embodiments mentioned above, but a cilia or the like may be planted on the outer surfaces of the applied bodies 10, 15, 17, 20 and 21 or a brush formed by bundling tapered polyester fibers may be attached.

In this case, the male threads 6b include intermittently arranged projection groups or spirally and intermittently arranged projection groups which have the same function as the thread ridge. Further, the female threads 4c include intermittently arranged projection groups, or spirally and intermittently arranged projection groups which have the same function as the thread ridge.

What is claimed is:

1. An applying filler extruding container capable of extruding an applying filler filled in a filling region within a container to a leading end side on the basis of a forward movement of a movable body arranged within said container, wherein said container comprises:
an operating tube structured in a closed-end tube and constituting a rear portion of the container; and
a main body tube structured such as to be relatively rotatable in a leading end side of the operating tube,
wherein a tubular body arranged so as to be non-rotatable and immovable in an axial direction and having a female thread in an inner circumference is provided in a middle portion of the inner circumference of said main body tube,
wherein a male thread engaging with said female thread is provided in an outer circumference of said movable body,
wherein a protruding portion is provided in a bottom portion of said operating tube so as to extend in an axial direction,
wherein an engagement portion provided in said movable body is engaged with an engagement portion provided in said protruding portion of said operating tube so as to be non-rotatable and movable in the axial direction, and a rotation preventing portion of said movable body is structured by the engagement portions,
wherein a click spring member structured in a tubular shape and having a click tooth and a compression spring portion is arranged in such a manner that said movable body passes through an inner side thereof, and a click mechanism is structured by being pinched between said tubular body and an inner portion of said operating tube, and
wherein when said operating tube and said main body tube are relatively rotated in one direction or the other direction corresponding to an opposite direction to the one direction, said movable body moves forward or backward by the engagement portion constituted by said female thread and said male thread and said rotation preventing portion, and a click feeling is given by said click mechanism at this time.

2. The applying filler extruding container as claimed in claim 1, wherein said click tooth is structured in a chevron shape having an upward incline and a downward incline along a circumferential direction.

3. The applying filler extruding container as claimed in claim 1, wherein said click spring member is arranged in such a manner that the click tooth is directed to a bottom portion side of said operating tube, and a predetermined engagement portion click engaging with said click tooth is provided in an inner portion of said operating tube.

4. The applying filler extruding container as claimed in claim 2, wherein said click spring member is arranged in such a manner that the click tooth is directed to a bottom portion side of said operating tube, and a predetermined engagement portion click engaging with said click tooth is provided in an inner portion of said operating tube.

5. The applying filler extruding container as claimed in claim 1, wherein said applying filler is constituted by a liquid filler.

6. The applying filler extruding container as claimed in claim 2, wherein said applying filler is constituted by a liquid filler.

7. The applying filler extruding container as claimed in claim 3, wherein said applying filler is constituted by a liquid filler.

8. The applying filler extruding container as claimed in claim 4, wherein said applying filler is constituted by a liquid filler.
